(19) United States
(12) Patent Application Publication
(10) Pub. No.: US 2025/0210224 A1
(43) Pub. Date: Jun. 26, 2025

(54) WIRE HARNESS ASSEMBLY

(71) Applicant: Yazaki Corporation, Tokyo (JP)

(72) Inventors: Satoshi SAITO, Shizuoka (JP); Hiromichi INOUE, Shizuoka (JP)

(73) Assignee: Yazaki Corporation, Tokyo (JP)

(21) Appl. No.: 18/978,329

(22) Filed: Dec. 12, 2024

(30) Foreign Application Priority Data
Dec. 20, 2023 (JP) 2023-215101

(51) Int. Cl. H01B 7/00

(52) U.S. Cl. CPC H01B 7/0045

(57) ABSTRACT

A wire harness assembly includes: a wire harness including an electric wire and a connector electrically connected to an end of the electric wire; and an assembly member in which the wire harness is arranged. The assembly member includes: a base; and a cover integrally provided on one surface side of the base. At least one of the base or the cover includes a holding portion configured to hold the electric wire.

### CROSS-REFERENCE TO RELATED APPLICATIONS

The present application is based on and claims the benefit of priority from the prior Japanese Patent Application No. 2023-215101, filed on Dec. 20, 2023, the entire contents of which are incorporated by reference herein.

### TECHNICAL FIELD

The disclosure relates to a wire harness assembly.

### BACKGROUND

JP 2015-67071 A describes a wire harness assembly including a wire harness and an assembly sheet as an assembly member in which the wire harness is arranged, the wire harness including an electric wire and a connector electrically connected to an end of the electric wire. In the wire harness assembly, the assembly sheet includes a soundproofing/heat insulating sheet as a base, and a bonding sheet as a cover integrally provided on one surface side of the soundproofing/heat insulating sheet. In the wire harness assembly, the bonding sheet is bonded onto one surface side of the soundproof/heat-insulating sheet in a state where the electric wire of the wire harness is arranged in a predetermined shape on one surface side of the soundproof/heat-insulating sheet.

### SUMMARY

In the wire harness assembly described above, when the base and the cover are integrated, the electric wire may move between the base and the cover, and the arrangement shape of the electric wire may be deformed. If the arrangement shape of the electric wire is deformed, the arrangement position of the connector of the wire harness may be changed, and it may be difficult to fit the connector.

The disclosure is directed to a wire harness assembly capable of stably holding an electric wire by an assembly member.

A wire harness assembly in accordance with some embodiments includes: a wire harness including an electric wire and a connector electrically connected to an end of the electric wire; and an assembly member in which the wire harness is arranged. The assembly member includes: a base; and a cover integrally provided on one surface side of the base. At least one of the base or the cover includes a holding portion configured to hold the electric wire.

According to the above-described configuration, in the wire harness assembly, the electric wire can be stably held by the assembly member.

### BRIEF DESCRIPTION OF THE DRAWINGS

FIG. 1 is a perspective view of a wire harness assembly according to an embodiment.

FIG. 2 is a top view of the wire harness assembly according to the present embodiment.

FIG. 3 is an exploded perspective view of the wire harness assembly according to the present embodiment.

FIG. 4 is a top view of a base of the wire harness assembly according to the present embodiment.

FIG. 5 is a side view illustrating an example of a groove of the wire harness assembly according to the present embodiment.

FIG. 6 is a side view illustrating another example of a groove of the wire harness assembly according to the present embodiment.

FIG. 7 is a side view illustrating another example of a groove of the wire harness assembly according to the present embodiment.

### DETAILED DESCRIPTION

Hereinafter, a wire harness assembly 1 according to an embodiment will be described in detail with reference to the drawings. Note that dimensional ratios in the drawings are exaggerated for convenience of explanation, and may be different from actual ratios.

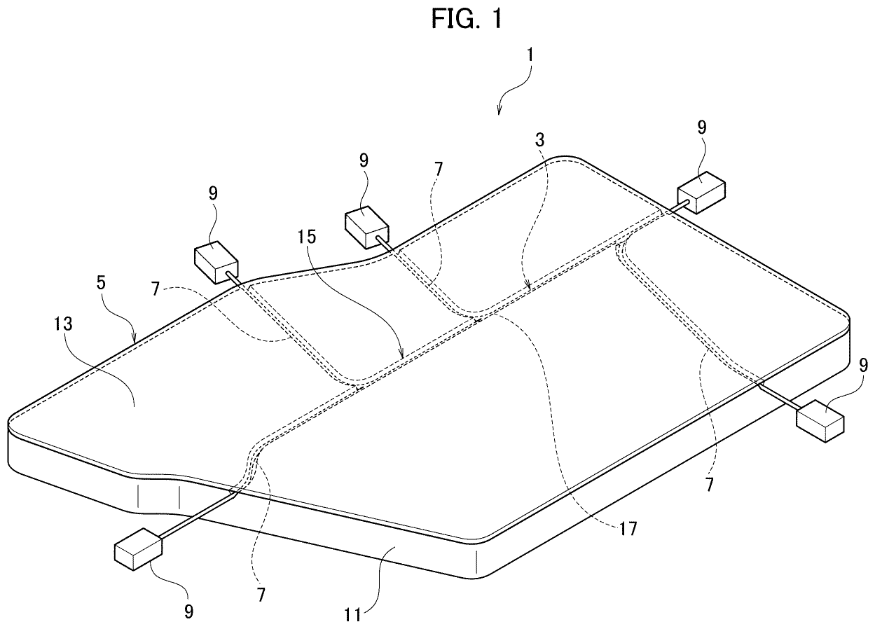

As illustrated in FIG. 1, the wire harness assembly 1 according to the present embodiment is applied to, for example, a wire harness 3 that electrically connects electrical components (not illustrated), e.g., a power supply mounted on a vehicle and a device or a device and a device. The wire harness 3 is arranged in a predetermined shape inside an assembly member 5 integrally assembled therewith. The wire harness assembly 1 is assembled to a target member (not illustrated), e.g., a door trim of a vehicle.

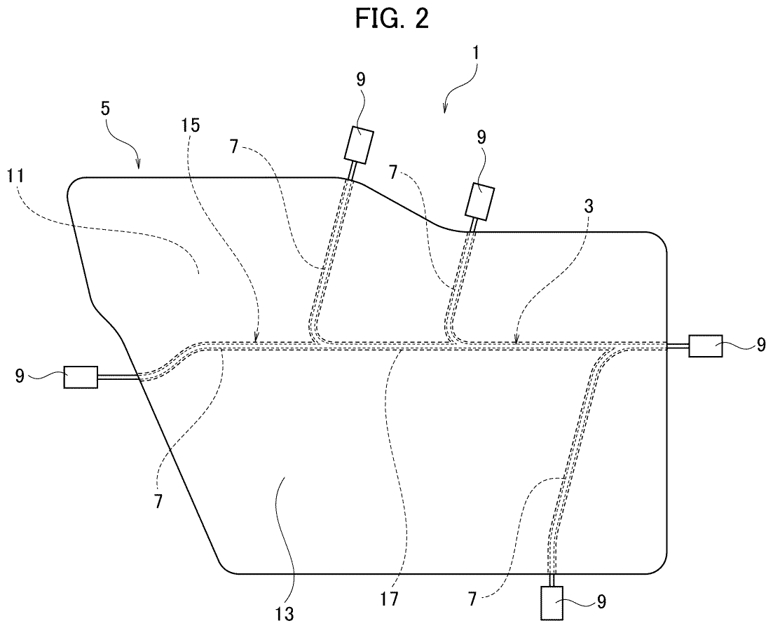

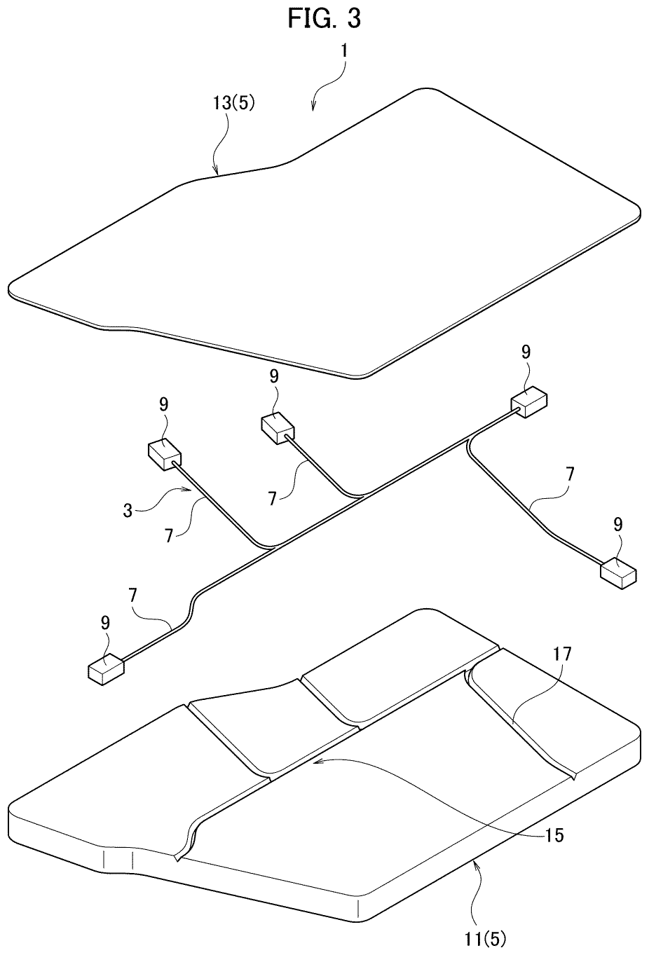

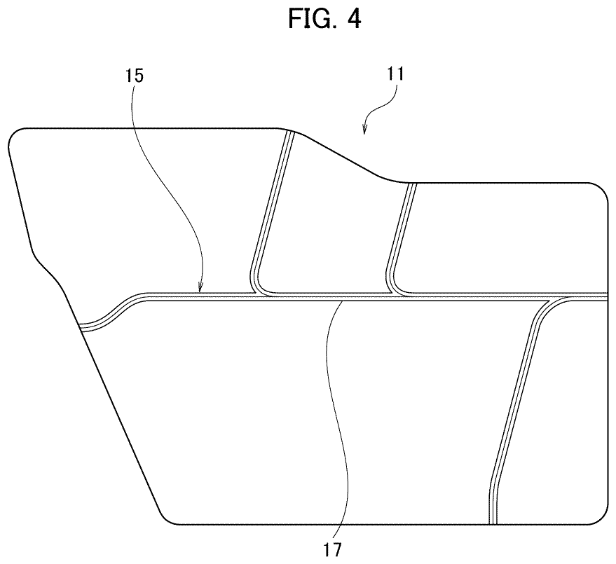

As illustrated in FIGS. 1 to 4, the wire harness assembly 1 includes a wire harness 3 and an assembly member 5.

As illustrated in FIGS. 1 to 3, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (four in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged in such a manner that ends on both sides thereof are exposed from the assembly member 5. The plurality of electric wires 7 are arranged in such a manner that the ends on one end sides are collected at one location, and the ends on the other end sides are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (five in the present embodiment) connectors 9 are used to correspond to the ends of the plurality of electric wires 7 exposed from the assembly member 5.

As illustrated in FIGS. 1 to 4, the assembly member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. On one surface side of the base 11, the plurality of (four in the present embodiment) electric wires 7 of the wire harness 3 are arranged in a predetermined shape. The ends of the plurality of electric wires 7, each of the electric wires 7 being arranged on the base 11, are exposed from an outer edge of the base 11 with a predetermined length, and the connectors 9 are arranged outside the base 11.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11. An adhesive is applied onto a surface of the cover 13 facing the base 11. The cover 13 is attached to one surface side of the base 11 in such a manner that the plurality of electric wires 7 are sandwiched between the cover 13 and the base 11. In a state where the cover 13 is integrally attached to the base 11, the plurality of electric wires 7 arranged in a predetermined shape are held between the base 11 and the cover 13. Therefore, the assembly member 5 can protect the electric wire 7 of the wire harness 3, and maintain the arrangement shape of the electric wire 7.

The connector 9 exposed from the assembly member 5 is fitted to a mating connector in a state where the wire harness assembly 1 is assembled to the target member. At this time, since the electric wire 7 is exposed from the outer edge of the assembly member 5 with a predetermined length, the connector 9 can freely move, making it easy to fit the connector 9 to a mating connector. By fitting the connector 9 to the mating connector, electrical components are electrically connected to each other.

Here, in a conventional wire harness assembly, a base or a cover does not have a structure for holding an electric wire of a wire harness arranged inside an assembly member. Therefore, when the base and the cover are integrated (attached), the electric wire may move between the base and the cover, and the arrangement shape of the electric wire may be deformed. If the arrangement shape of the electric wire is deformed, the arrangement position of the connector of the wire harness with respect to the assembly member is changed. If the wire harness assembly in which the arrangement position of the connector is changed is assembled to a target member, the position of the connector is different from that of the mating connector, and it is difficult to fit the connectors.

On the other hand, in the wire harness assembly 1 according to the present embodiment, at least one of the base 11 or the cover 13 includes a holding portion 15 that holds the electric wire 7 of the wire harness 3 arranged inside the assembly member 5. In the following description, it is assumed that the holding portion 15 is provided in the base 11, but the holding portion 15 may be provided in the cover 13.

The holding portion 15 is provided on one surface side of the base 11 that is a surface of the base 11 facing the cover 13. The holding portion 15 is provided in the base 11 along the electric wire 7 in accordance with the arrangement shape of the electric wire 7. The holding portion 15 is a groove 17 continuous along the electric wire 7 and capable of accommodating the electric wire 7 therein. The groove 17 is open on both end sides (connector 9 side) at both ends of the electric wire 7. The electric wire 7 is accommodated in the groove 17 that is the holding portion 15 before the base 11 and the cover 13 are joined together. In a state where the electric wire 7 is held by the holding portion 15, the arrangement shape of the electric wire 7 with respect to the assembly member 5 is maintained. Therefore, when the base 11 and the cover 13 are integrated (attached), the electric wire 7 does not move between the base 11 and the cover 13, and the arrangement shape of the electric wire 7 is not deformed. If the arrangement shape of the electric wire 7 is not deformed, the arrangement position of the connector 9 of the wire harness 3 with respect to the assembly member 5 does not change. Therefore, in a state where the wire harness assembly 1 is assembled to a target member, the position of the connector 9 coincides with the position of the mating connector, and the connector 9 can be easily fitted. In addition, since the holding portion 15 is the groove 17 continuous along the electric wire 7 to accommodate the electric wire 7, it is possible to suppress the portion where the electric wire 7 is arranged from protruding from an outer surface of the assembly member 5 in a state where the base 11 and the cover 13 are integrated. Therefore, the size of the wire harness assembly 1 can be reduced.

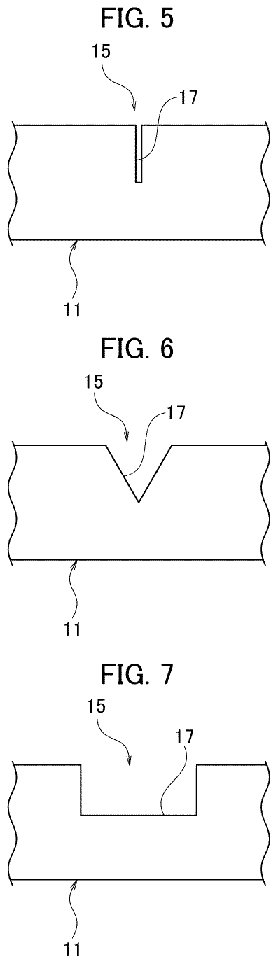

Here, an example of the groove 17 will be described with reference to FIGS. 5 to 7. The groove 17 illustrated in FIG. 5 is formed by making a cut on one surface side of the base 11. The electric wire 7 is accommodated in the cut-shaped groove 17 to be press-fitted. The cut-shaped groove 17 has high adhesion with the electric wire 7. Therefore, the movement of the electric wire 7 can be stably restricted. The groove 17 illustrated in FIG. 6 is formed in a V-shaped cross section on one surface side of the base 11. The V-shaped groove 17 has high adhesion with the electric wire 7 while requiring small force for inserting the electric wire 7 into the groove 17. Therefore, it is possible to improve assemblability while restricting the movement of the electric wire 7. The groove 17 illustrated in FIG. 7 is formed in a U-shaped cross section on one surface side of the base 11. The U-shaped groove 17 requires small force for inserting the electric wire 7 into the groove 17. Therefore, assemblability can be improved. The groove 17 may have any shape as long as the electric wire 7 can be accommodated therein.

The wire harness assembly 1 according to the present embodiment includes a wire harness 3 including an electric wire 7 and a connector 9 electrically connected to an end of the electric wire 7, and an assembly member 5 in which the wire harness 3 is arranged. The assembly member 5 includes a base 11 and a cover 13 integrally provided on one surface side of the base 11. At least one of the base 11 or the cover 13 includes a holding portion 15 that holds the electric wire 7.

In a state where the electric wire 7 is held by the holding portion 15, the arrangement shape of the electric wire 7 with respect to the assembly member 5 is maintained. Therefore, when the base 11 and the cover 13 are integrated, the electric wire 7 does not move between the base 11 and the cover 13, and the arrangement shape of the electric wire 7 is not deformed. If the arrangement shape of the electric wire 7 is not deformed, the arrangement position of the connector 9 of the wire harness 3 with respect to the assembly member 5 does not change. Therefore, in a state where the wire harness assembly 1 is assembled to a target member, the position of the connector 9 coincides with the position of the mating connector, and the connector 9 can be easily fitted.

Therefore, in the wire harness assembly 1, the electric wire 7 can be stably held by the assembly member 5.

The holding portion 15 is a groove 17 continuous along the electric wire 7 to accommodate the electric wire 7.

Therefore, it is possible to suppress the portion where the electric wire 7 is arranged from protruding from the outer surface of the assembly member 5 in a state where the base 11 and the cover 13 are integrated, reducing the size of the wire harness assembly 1.

In the above-described embodiment, the holding portion 15 is provided in the base 11, but the present invention is not limited thereto, and the holding portion 15 may be provided in the cover 13. The holding portion 15 may be provided on both the base 11 and the cover 13.

In the above-described embodiment, the holding portion 15 is the groove 17, but the present invention is not limited thereto. For example, the holding portion 15 may be a pair of grip portions or the like protruding toward the electric wire 7 to grip the electric wire 7, and the holding portion 15 may have any form as long as the electric wire 7 can be held thereby. In a case where the holding portion 15 is a pair of grip portions, a plurality of pairs of grip portions may be arranged along the electric wire 7 in accordance with the arrangement shape of the electric wire 7.

In the above-described embodiment, the number of the electric wires 7 in the wire harness 3 is four, but the present invention is not limited thereto, and the number of the electric wires 7 may be three or less or may be five or more. In the above-described embodiments, one end sides of the plurality of electric wires 7 are collected into one connector 9, but the present invention is not limited thereto, and the connector 9 may be provided on each of one end sides of the plurality of electric wires 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
an assembly member in which the wire harness is arranged, wherein
the assembly member includes:
a base; and
a cover integrally provided on one surface side of the base, and
at least one of the base or the cover includes a holding portion configured to hold the electric wire.

2. The wire harness assembly according to claim 1, wherein the holding portion is a groove continuous along the electric wire to accommodate the electric wire.
